(19) United States
(12) Patent Application Publication
(10) Pub. No.: US 2018/0039563 A1
(43) Pub. Date: Feb. 8, 2018

(54) System And Method For A Security Intelligence Software Development Platform

(71) Applicant: proServices Corp., Trenton, NJ (US)

(72) Inventor: Brian Gill-Price, Langhorne, PA (US)

(73) Assignee: proServices Corp., Trenton, NJ (US)

(21) Appl. No.: 15/227,171

(22) Filed: Aug. 3, 2016

(51) Int. Cl. G06F 11/36; G06F 21/57

(52) U.S. Cl. CPC G06F 11/3664; G06F 21/577; G06F 2221/033

(57) ABSTRACT

A system for security and software development intelligence is provided. The system includes an ontology infrastructure, which includes a web ontology language, an ontology rule system, and an ontology inference engine. The system also includes an adjustable ratings calculation module for calculating a rating of a plurality of coding errors located in the web ontology language. Moreover, the system includes a data fidelity and reduction module for reducing the complexity of the web ontology language.

### BACKGROUND

### Field Of The Disclosure

The present disclosure relates generally to systems for providing an architectural platform for software development. More specifically, the present disclosure relates to a system and method for a security intelligence software development platform.

### Related Art

Software is an integral part of society powering devices from phones to cars. As such dependency of these systems working properly is increasing exponentially each year. When software intensive systems become compromised, it has a cascading effect and impact on major operations. Companies and organizations are advancing the state of the art on how to build products and services dependent on software, however the technologies to help them ensure what they are building is both secure and reliable are dated in their approach to mitigate such risks proactively. For example, a software developer has access to a plethora of tools designed to identify various security, production, and implementation risks for the code the developer is working on. The code may be hundreds of thousands, even millions, of lines long and the many tools assessing the code will output a massive amount of data too overwhelming for a software developer to address. This creates a “big data” problem which is a popular term now used to describe the collection of massive amounts of data. The large amount of data provides engineers and scientists a sandbox to look for patterns or signatures in the data to answer questions. Having a large amount of data can also create issues with respect to the quality of data, which requires eliminating “noisy” bad data. Therefore, there exists a need to solve the “big data” problem and the quality of data issue by providing a technical architectural solution.

### SUMMARY

Preferred embodiments of the present disclosure address the “big data” problem and the quality of data issue. An underlying software tool, e.g., a third party software product, might be used to analyze a subject piece of code for security flaws or errors, for example, and output numerous identified such flaws or errors. Further, numerous (e.g., hundreds) of these underlying software tools might be utilized to analyze the subject code, with each one of the (potentially hundreds) of software tools searching and outputting for different (and sometimes the same) flaws and errors. This large “big data” output from numerous disparate and overlapping underlying software tools is difficult to analyze in the aggregate. Preferred embodiments of the present invention can be provided to overlay a virtually endless number of underlying software tools for analyzing subject code, aggregate the data, and provide customized machine learning attuned to such process.

In example embodiments, a system for security and software development intelligence is provided. The example system includes an ontology infrastructure, which includes a web ontology language, an ontology rule system, and an ontology inference engine. The example system also includes an adjustable ratings calculation module for calculating a rating of a plurality of coding errors located in the web ontology language. Moreover, the example system includes a data fidelity and reduction module for reducing the complexity of the web ontology language.

In example embodiments, a method for security and software development intelligence is also provided. The example method includes the steps of providing an ontology infrastructure including a web ontology language, an ontology rule system, and an ontology inference engine. The example method also includes the step of providing an adjustable ratings calculation module for calculating a rating of a plurality of coding errors located in the web ontology language. Also, the example method can include the step of providing a data fidelity and reduction module for reducing the complexity of the web ontology language.

### BRIEF DESCRIPTION OF THE DRAWINGS

The foregoing features of the disclosure will be apparent from the following Detailed Description, taken in connection with the accompanying drawings, in which:

FIG. 1 is a diagram of an example hardware implementation of the present disclosure.

FIG. 2 is a diagram of an example system of the present disclosure;

FIG. 3 is a flowchart of an example process of gathering data from the software tools;

FIG. 4 is an example ontology tree portion;

FIG. 5 is a flowchart of example processes in the ontology infrastructure of an example system of the present disclosure;

FIG. 6 is a flowchart of an example adjustable ratings calculation module of an example system of the present disclosure;

FIG. 7 is a flowchart of an example data fidelity and reduction module of an example system of the present disclosure;

FIG. 8 is a flowchart of an example machine learning module of an example system of the present disclosure; and

FIG. 9 is an example output layer of an example system of the present disclosure.

### DETAILED DESCRIPTION

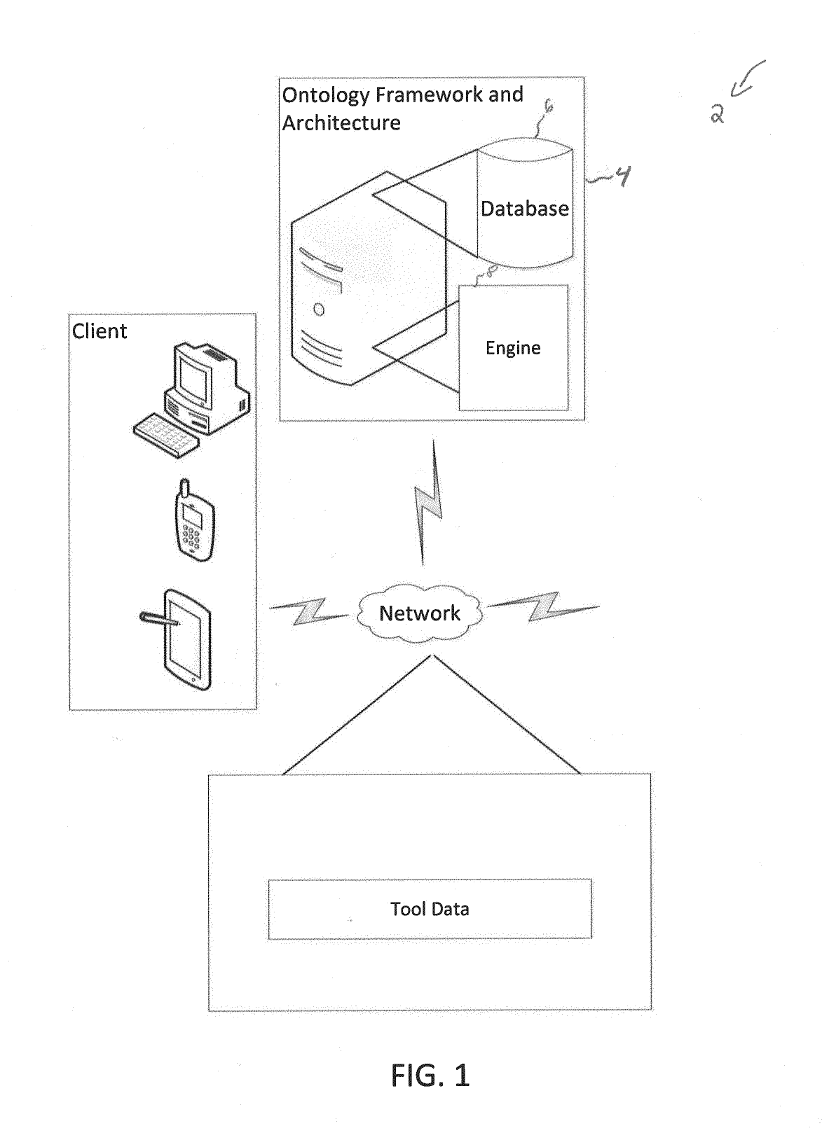

The present disclosure relates to a system and method for signal processing in communications systems, as discussed in detail below in connection with FIGS. 1-9.

Referring to FIG. 1, a diagram of the computing system on which the present disclosure could be implemented. The computing system is indicated generally at 2, which includes a computer system 4 (e.g., a server) having a database 6 stored therein and an engine 8. The computer system 2 could be any suitable computer server (e.g., a server with an INTEL microprocessor, multiple processors, multiple processing cores) running any suitable operating system (e.g., Windows by Microsoft, etc.). The database 6 could be stored on the computer system 2 and/or located externally (e.g., in a separate database server in communication with the computer system 2). The computer system 4 can includes a memory and processor for executing computer instructs stored thereon.

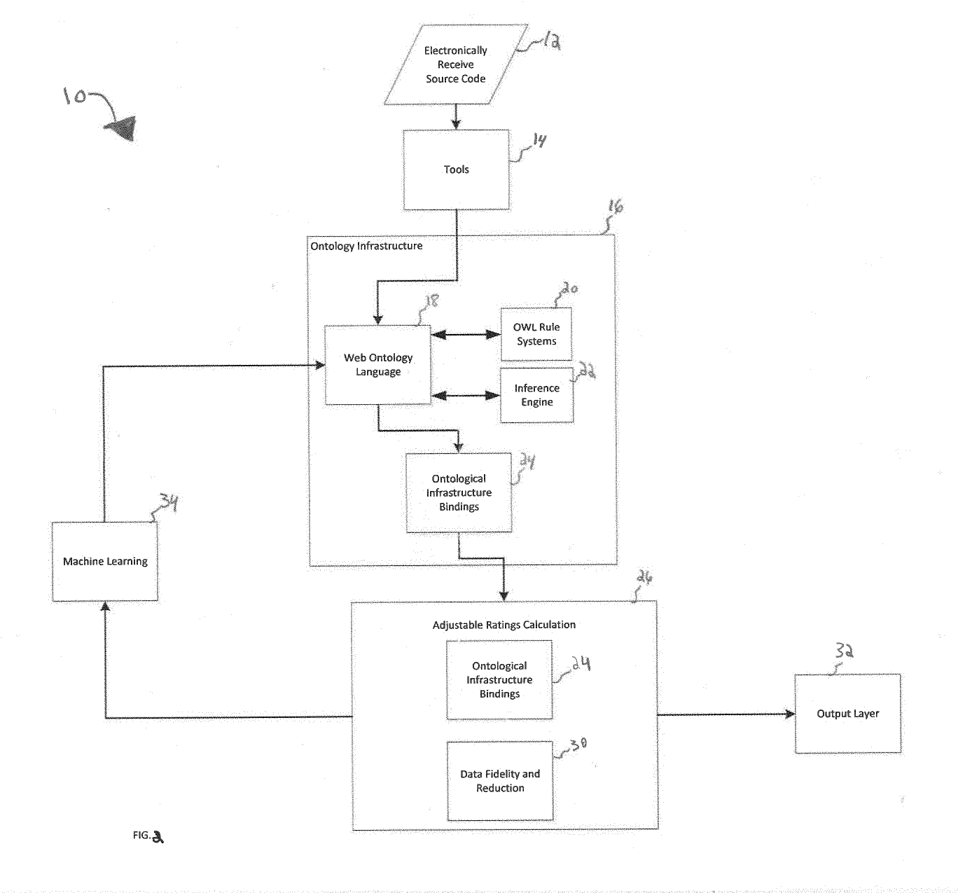

Referring to FIG. 2, a block diagram of an example system 10 of the present disclosure will be explained in greater detail. The system 10 first electronically receives source code 12 which is received by a plurality of tools 14. The plurality of tools 14 identify possible security flaws, errors, anomalies, and/or other issues with the source code 12 desired for identification, and the tools 14 output large amounts of data, some of which includes disparate and/or common instances of such flaws, errors, anomalies, etc. The data is then received by an ontology infrastructure 16 which is located on the computer system 4 and includes a web ontology language (“OWL”) 18, rule systems 20, inference engine 22 and ontology infrastructure bindings 24. An adjustable ratings calculation module 26 is executed by a processor and then called to calculate a rating for the nodes in the OWL 18. For each node, the data fidelity and reduction module 30 can be called to help reduce the big data problem described above. The data fidelity and reduction module 30 is executed by a processor on the computer system 4. Finally, the results are sent to the output layer 32 and the machine learning module 34.

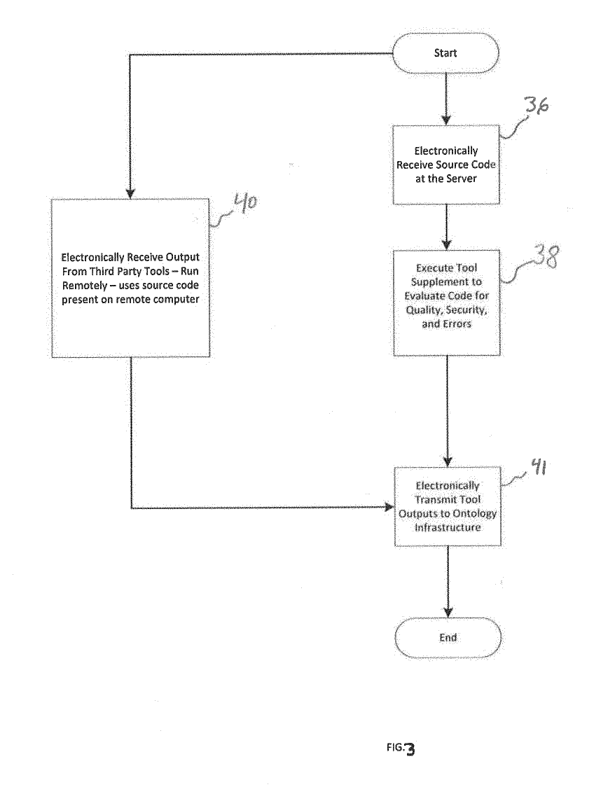

As shown in FIG. 3, the step of electronically receiving source code 12 is shown in greater detail. In step 36, the system 10 electronically receives source code at server. In step 38, the system 10 executes a tool supplement to evaluate the source code for quality and security errors. Tool supplement can be on the computer system 4 or optionally on another similar system to it such as remote distributed computing. Each tool can be executed in a serial fashion to avoid interactions between tools, but support for parallel execution is provided for in a queue and distribution module. Each tool is invoked for execution per its manufacturer requirements. Output is converted by tool wrapper modules, which are customized for each tool, that post process output into any suitable format such as Microsoft Excel CSV format of data. This data can then be stored and/or merged and further processed in other modules in the system 10. Meanwhile in step 40, the system 10 receives output from third party tools. In step 41, both the output from steps 38 and 40 are received by the ontology infrastructure 16 (FIG. 2).

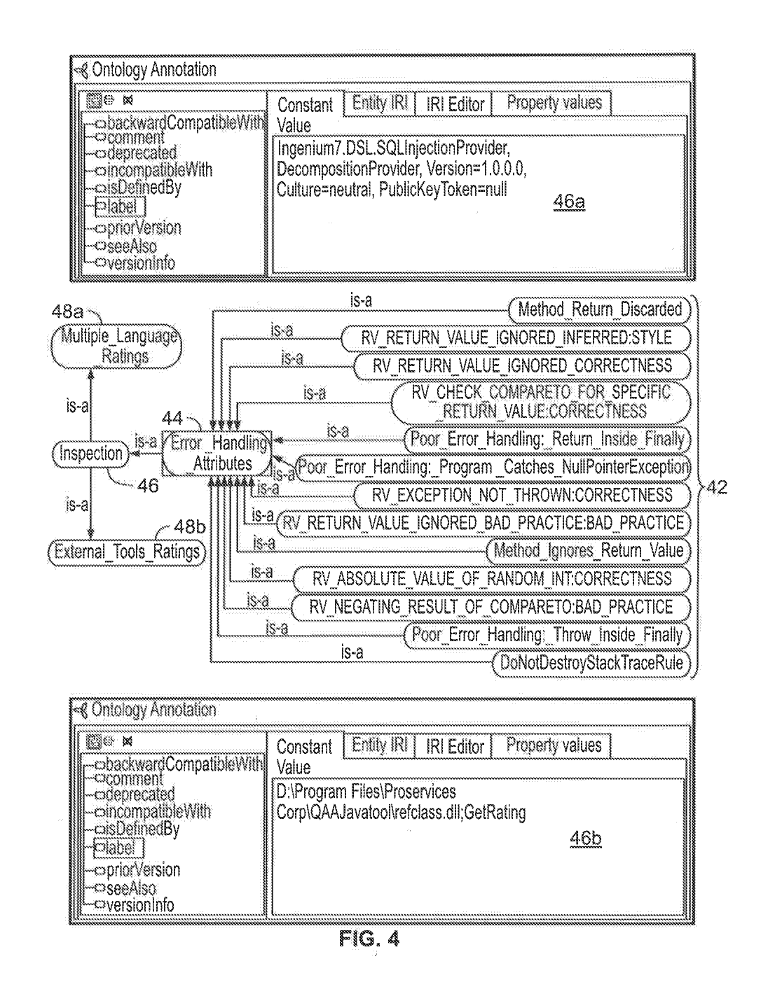

The disclosure of the present application can use existing public domain technologies such as the W3C standard for the OWL 18. The public domain technologies can be enhanced to accept any ontology, taxonomy, and hierarchy of categories as an organization structure. This allows the technical complexity of the output from the plurality of tools 14 to be reduced so that a user can interact, understand, and provide input into the system 10. For example, FIG. 4 shows greater detail of the OWL 18 of the disclosure of the present application. The OWL 18 may include a plurality of coding errors 42, which may be organized as a general coding error 44. For example, the error Method_Return_Discarded is a type of Error Handling Attribute, which is represented by virtue of the ontology tree structure embedded within the OWL 18 and as shown in FIG. 4. Furthermore, the general coding error 44 can fall under a tree node, such as an action 46. The action 46 is an interface to procedural activities (business process, codified algorithms) that is required in order to address the general coding error 44 and the plurality of coding errors 42. The action 46 can be automated or can be managed or reviewed by less technical people to understand the issues to be addressed in the software development lifecycle. An action can be associated as shown in overlay 46a where a node in the tree contains two attributes Type with value “decomposition” and label. The attribute “label” has a value “Ingenium7.DSL.SQLInjectionProvider,DecompositionProvider, Version=1.0.0.0,Culture=neutral, PublicKeyToken=null” which specifies how to find the customer supplied action 46. Finally, similar to overlay 46a, the action 46 can additionally be classified by a ratings 48. Ratings 48 can have a pair of attributes 46b Type with value “classInfo” set to “Rating_WeightedAverageCATIII” (which can be a user supplied node in the tree), which in turn contains an attribute label which has a value “D:\Program Files\Proservices Corp\QAAJavatool\refclass.dll;GetRating”. The label value in both overlay 46a and attribute 46b locates a program on the disk, and the method within the program code. Users can in like fashion construct their own nodes in the tree, inference to create their own nodes in the tree, and extend the system by adding actions 46 and ratings 48. Ratings 48 can compute based on data associated with nodes, a conversion from data to a numerical scale rating. The resulting rating is an integer number from 0 to 100 representing a grade akin to those given students on a test. Ratings 48 can then later be shown in the user interface (e.g. dials, color bars etc.).

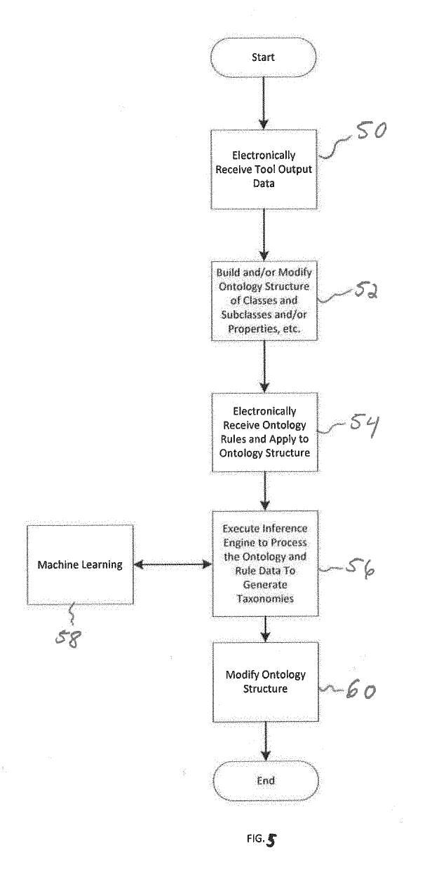

Reference will now be made to FIG. 5, which shows the process of creating and modifying the OWL 18 in the ontology infrastructure 16. In step 50, the ontology infrastructure 16 electronically receives the tool output data from steps 38 and 40. In step 52, the OWL 18 can be created and customized for the unique specifications of the system 10. Any type of classification and structure can be used. FIG. 4 as discussed above illustrates an example tree structure that can be used in the system 10. Depending on the tools being used, and the types of action 40 that is needed, a unique and fully customizable ontology tree can be used and adapted for the system 10. In step 54, the system 10 receives the ontology rules that apply to the ontology tree and in step 56 the inference engine can be applied to the OWL 18 and the rules to generate, regenerate, or modify existing taxonomies and reduce the amount of data from the tool output. Applying the inference engine to the OWL 18 can also reorganize the data by priority such as high, medium, or low priority. The inference engine also can modify plug and play processes so that some data is not passed on to developers for review. Early in the software lifecycle, it may be desirable to pass on only small subsets of security data. For example, attributes on nodes “NoNetworkSecurityRisk” and on tool categories can have inferencing build category trees in which none of the security categories that apply to network risks will be included. This significantly reduces the volume of data for that sub-tree. It is possible to refine many categories further by study identifying technological drivers under which they apply. Machine learning step 58 can be input into the system to modify the ontology tree in step 60, which will be explained in greater detail below. The disclosure of the present application makes use of multiple sources of inference engines to manipulate the ontological infrastructure. This enables unique use of collections of ontologies to describe bindings to interfaces. This in turn can be used to manipulate multiple dimensions of behavior. It also supports use of taxonomic reasoning, not solely hierarchies to be expressed. For example, SQL injection attacks can be a serious concern for software security and a tool called “RuleRunner” can identify various instances of SQL injection vulnerabilities across multiple files of code. Inference engines can be applied to SQL injection output data which includes the use of multiple tools and attributes to infer a group of data into a dynamically modified taxonomy.

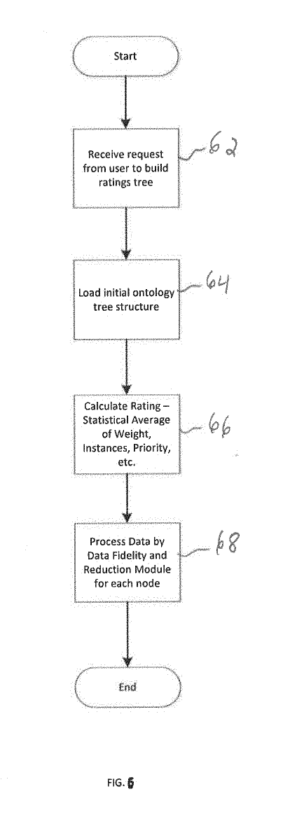

Reference will now be made to FIG. 6 in greater detail. In step 62, the user can call the adjustable ratings calculation module 26 to calculate a rating of the severity of the general coding errors 44 once the OWL 18 tree structure is created. It should be noted that the rating calculation can occur for any level of node in the OWL 18. In step 64, the system 10 can load the initial ontology tree structure, a dynamically modified tree at runtime which is a revision to the initial ontology tree, or the ontology tree after machine learning module 34 modifies the OWL 18 in step 58. Then in step 66, the system 10 can calculate a rating for each node in the OWL 18 based on a statistical average of the weight, priority, and instances of a particular error 42 or general error 44. The assignment of weight and priority can be fully customizable, including but not limited to the machine learning module 34, in the system 10 and depending on the weights and priorities given, this will affect the statistical average of the ratings calculation. Furthermore, any statistical average formula can be used in the system 10, which will be apparent to those of ordinary skill in the art. The adjustable ratings calculation module 26 can help focus and filter data driven by the rating, which supports reduction in the data the user needs to pay attention to. In step 68, for each node, the data fidelity and reduction module 30 can be called to reduce the big data problem, as shall now be further discussed.

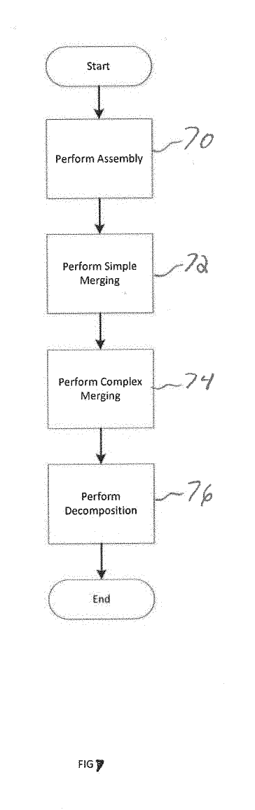

Referring to FIG. 7, in step 70, the system 10 performs assembly on the OWL 18 which bolts and concatenates tree structures together. The bolting can occur dynamically at runtime. The tree structures to be combined can be from the OWL 18 loaded in step 64 or it can be from a tree loaded from cache, for example. In step 72, the system 10 can perform simple merging which sums counts of base-data into a resulting tree. Simple merging can occur on various just-in-time/on-demand points. Different portions of the OWL 18 can be analyzed for elements that can be merged with other sub-trees in the OWL 18. The merging can be rules drives by the rule system 20 or it can be implemented with algorithms known to those of ordinary skill in the art. Implementation can be done by C# programming language reflection, which is called reflection as added on OWL 18. In the reflection module, a programmer can manipulate the tree, request values to manipulate through mathematics, or supply helper functions via a supplied interface. These operations are assumed to be an order of magnitude faster than complex cases, and are consequently callable in GUI/dashboard updates as well as in batch calculation points in processing. The system 10 can also perform complex merging in step 74. Complex merging is similar to simple merging except complex merging can involve more factors in the merging analysis and also several more data sources or tree nodes in the OWL 18. Furthermore, merging can be supported by normalizing data. For example, if in the rating above in step 66, the data is normalized such that the system 10 has 100,000 lines of code and there are 1,000 instances for a node in the OWL 18, then the code density normalized value is 1 per 100. If a second revision of the code has a density of 1 per 1,000 lines of code, this result can be combined to form a trending chart, which can be used to do a complex merge of the full system and revised code portion of the system. The result can be combined into GUI dashboard such as in output layer 32. Merging can also occur on by tool categories. For example, if a tool finds certain instances in a given category of errors, and a second tool finds instances in a given category that is semantically equivalent and reported in the same fashion, then the merge module can remove all the duplicates and simplify the data. There are many ways to perform merging and the disclosure of the present application can employ any suitable merging algorithm means known to those of skill in the art. Implementation is by C# programming language reflection, which is called reflection as added on OWL 18. In the reflection module, a programmer can manipulate the tree, request values to manipulate in math, or perform external access to system 10, by helper functions via a supplied interface. These operations are assumed to be an order of magnitude slower than simple cases, and are consequently only called in batch calculation points in processing. Finally, in step 76, the system 10 can perform decomposition of the data. Decomposition provides a customer controllable mechanism for splitting/disassembling of data. A set of attributes and parameters that are important can be decomposed in the OWL 18 to ensure proper treatment of those attributes or parameters.

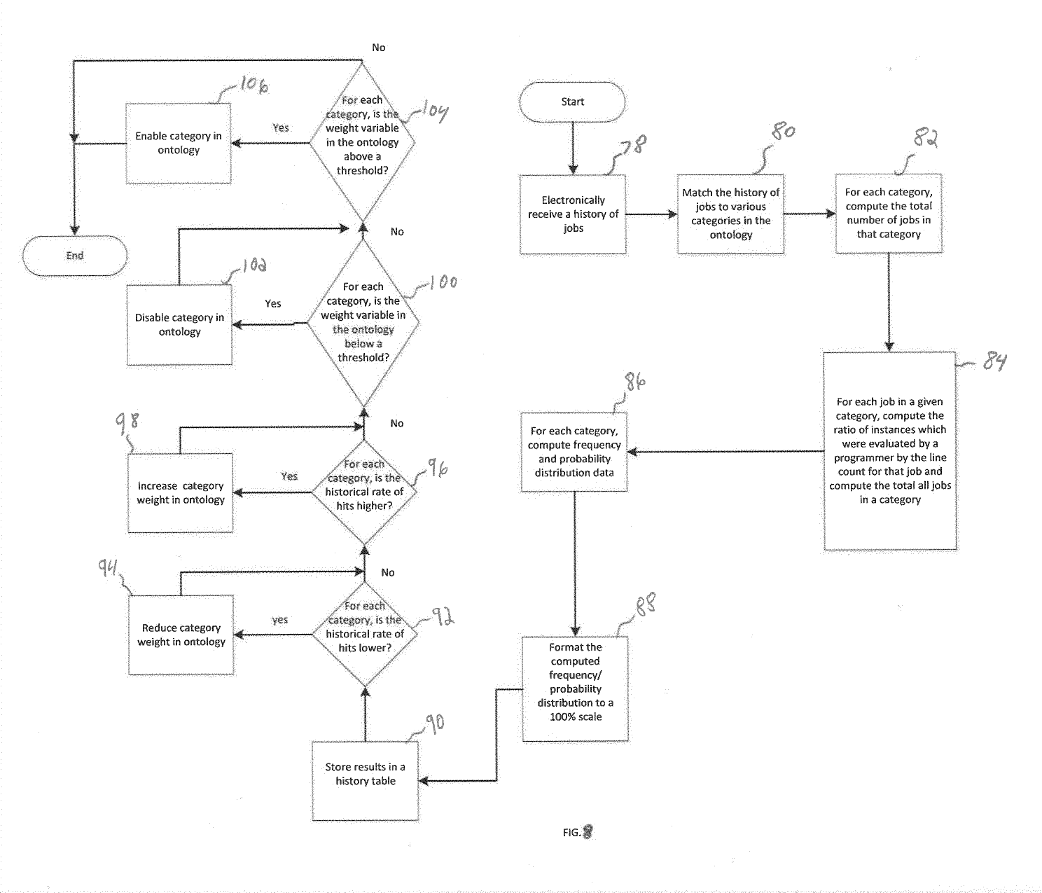

Reference will now be made to FIG. 8 in greater detail, which illustrates one of the multiple aspects of the machine learning aspect of the present disclosure. The machine learning module 34 performs historical data mining to provide feedback channels to the OWL 18. In step 78, the system 10 electronically receives a history of jobs. In step 80, the history of jobs is matched to various categories in the OWL 18. In step 82, the total number of jobs in each category is computed. In step 84, or each job in a given category, the system 10 computes the ratio of instances which were evaluated by a programmer by the line count for that job and compute the total all jobs in a category. In step 86, for each category, the system 10 can compute frequency and probability distribution data. In step 88, the data from step 86 can be formatted to a one hundred percent scale. In step 90, the results are stored in a history table. In step 92, a determination is made as to whether the historical rate of hits is lower than a certain category threshold stored in the OWL 18. The same elaboration step occurs in step 96 discussed below. If a positive determination is made, the weight of that category is reduced in the OWL 18 in step 94. If a negative determination is made or after step 94, a determination is made if the historical rate of higher for a given category in step 96. If a positive determination is made, the weight of that category is increased in step 98 and the system 10 moves to step 100. If a negative determination is made, the system 10 also proceeds to step 100. In step 100, a determination is made for each category if the weight variable is below a certain threshold. The weight variable can be an attribute in the OWL 18. If a positive determination is made, the ontology node is disabled in the OWL 18 in step 102 and the system 10 proceeds to step 104. If a negative determination is made, the system 10 proceeds to step 104. In step 104, a determination is made as whether the weight variable is greater than a certain threshold. If a positive determination is made, the ontology node is enabled in the OWL 18 in step 106. If a negative determination is made or after step 106, the machine learning module ends.

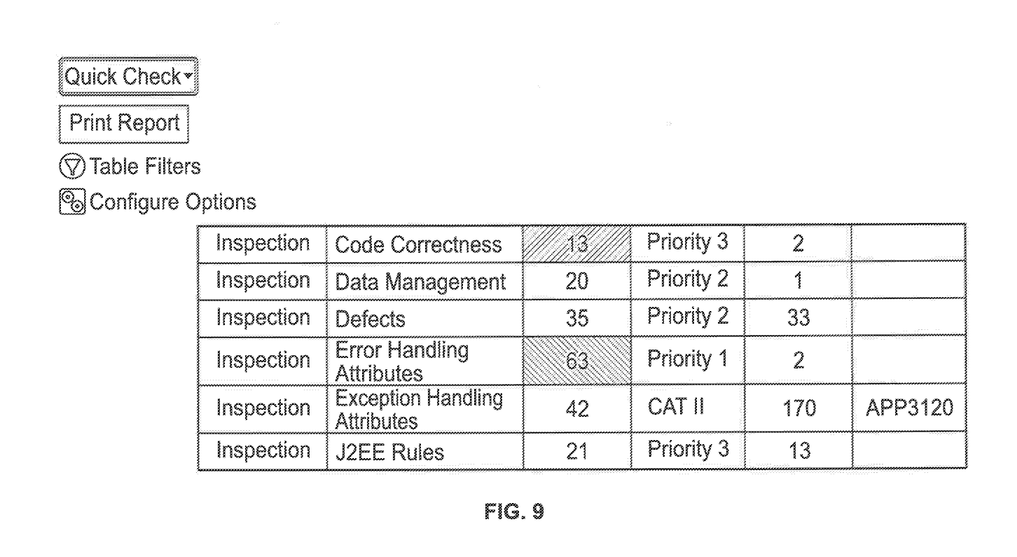

Referring to FIG. 9, an example embodiment of the output layer 32 is shown in greater detail. For example, the action 46 can be shown in a column and the corresponding general coding error 44 can also be shown next to it. Furthermore, the rating can be displayed in a column adjacent to the general coding error 44, and it can also be color coded based on the severity of the rating calculated by the adjustable ratings module 26. A priority of the general coding error 44 can also be displayed in the output layer 32, as shown in FIG. 8. Finally, number of instances of the general coding error 44 can be shown. It should be noted that the disclosure of the present application is not limited to the specific embodiment of the output layer 32 as shown in FIG. 9. The output layer is fully customizable in the present application and includes multiple implementations beyond that shown here.

In the framework of the application of the present invention, there are no domain specific elements. Frameworks support execution of a wide variety of end-user extensible components. Purposes of extensibility can be business drivers of unique configurations, changes in processing engendered by “learning from past results” (optimization), performance improvements, and specialization (problems requiring less of the total space, but potentially greater depth in specific areas). As such, given that a framework is described/implemented that has no hardcoded domain knowledge, the disclosure of the present application permits applicability to a wide variety of applications.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A computer-readable medium used with a computer system having a server with memory and for processing coding errors in subject code, the computer-readable medium, being at least one of distributed and non-distributed, and having stored thereon;
an ontology infrastructure including a web ontology language, an ontology rule system, and an ontology inference engine to identify coding errors in subject code;
an adjustable ratings calculation module calculating ratings for the coding errors located in the web ontology language;
a data fidelity and reduction module reducing the complexity of the coding errors.

2. The system of claim 1, further comprising a machine learning module for mining historical data and providing feedback channels to the web ontology language.

3. The system of claim 1, wherein the data fidelity and reduction module performs assembly to bolt and concatenate the web ontology language.

4. The system of claim 1, wherein the data fidelity and reduction module performs simple merging.

5. The system of claim 1, wherein the data fidelity and reduction module performs complex merging.

6. The system of claim 1, wherein the data fidelity and reduction module performs decomposition.

7. The system of claim 1, wherein the web ontology language includes an action for addressing at least one coding error.

8. The system of claim 7, further comprising an output layer including the action and the rating of at least one coding error.

9. The system of claim 1, further comprising a tool supplement for evaluating quality and security issues of the subject code.
